(19) United States
(12) Patent Application Publication
(10) Pub. No.: US 2016/0291795 A1
(43) Pub. Date: Oct. 6, 2016

(54) CALIBRATION METHOD, NON-TRANSITORY COMPUTER-READABLE RECORDING MEDIUM, AND CALIBRATION DEVICE

(71) Applicant: FUJITSU LIMITED, Kawasaki-shi (JP)

(72) Inventor: Bin CHEN, Machida (JP)

(73) Assignee: FUJITSU LIMITED, Kawasaki-shi (JP)

(21) Appl. No.: 15/070,488

(22) Filed: Mar. 15, 2016

(30) Foreign Application Priority Data
Mar. 30, 2015 (JP) 2015-068318

(51) Int. Cl. G06F 3/041

(52) U.S. Cl. CPC G06F 3/0418

(57) ABSTRACT

A calibration method performed by a computer. The calibration method includes making a display device display a figure indicating a touch route, receiving a plurality of detection results from a detection device, each of the plurality of detection results including one or more touch positions on a surface on which the figure is displayed in each detection timing, extracting one or more loci based on the plurality of detection results, and when the extracted one or more loci include a plurality of loci, executing a calibration based on a corresponding locus coinciding with or approximate to the figure, the corresponding locus being included in the plurality of loci.

### CROSS-REFERENCE TO RELATED APPLICATION

This application is based upon and claims the benefit of priority of the prior Japanese Patent Application No. 2015-068318, filed on Mar. 30, 2015, the entire contents of which are incorporated herein by reference.

### FIELD

The embodiment disclosed herein is related to a calibration in a display system.

### BACKGROUND

Calibration is performed in a case where a display system combining a display device and a plane scanning sensor is used. In the calibration, a parameter for performing coordinate transformation between a display coordinate system in the display device and a detection coordinate system in the plane scanning sensor is calculated for example on the basis of a matching sample associating the position of a given point in a display surface with a position detected as a result of touching the point.

However, the plane scanning sensor may be affected by noise and thus detect another position other than the position touched by a user. The display system may not operate correctly when calibration is performed on the basis of such erroneous detection.

### SUMMARY

According to an aspect of the embodiment, A calibration method performed by a computer, the calibration method including making a display device display a figure indicating a touch route, receiving a plurality of detection results from a detection device, each of the plurality of detection results including one or more touch positions on a surface on which the figure is displayed in each detection timing, extracting one or more loci based on the plurality of detection results, and when the extracted one or more loci include a plurality of loci, executing a calibration based on a corresponding locus coinciding with or approximate to the figure, the corresponding locus being included in the plurality of loci.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a display system;

FIG. 2 is a diagram illustrating a state of scanning;

FIG. 3 is a diagram illustrating an example of a module configuration of a control device;

FIG. 4 is a diagram illustrating an example of a flow of main processing;

FIG. 5 is a diagram illustrating an example of a figure;

FIG. 6 is a diagram illustrating an example of a flow of detection processing;

FIG. 7 is a diagram illustrating an example of detection data;

FIG. 8 is a diagram illustrating an example of loci;

FIG. 9 is a diagram illustrating an example of a flow of first extraction processing;

FIG. 10 is a diagram illustrating an example of a locus table;

FIG. 11 is a diagram illustrating an example of a locus table;

FIG. 12 is a diagram illustrating an example of a locus table;

FIG. 13 is a diagram illustrating an example of a flow of selection processing;

FIG. 14 is a diagram illustrating an example of a flow of second extraction processing;

FIG. 15 is a diagram illustrating an example of sample data;

FIG. 16 is a diagram illustrating an example of a figure;

FIG. 17 is a diagram illustrating an example of a figure; and

FIG. 18 is a functional block diagram of a computer.

### DESCRIPTION OF EMBODIMENT

In one aspect, it is one of the purposes of the present embodiment to perform calibration more correctly for a display system detecting a touch position.

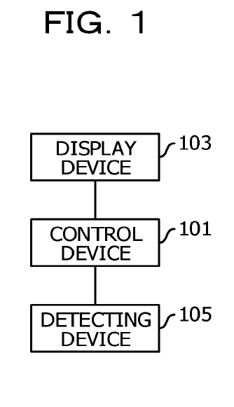

FIG. 1 illustrates an example of a configuration of a display system. A control device 101 is coupled to a display device 103 and a detecting device 105. The control device 101 in the present embodiment performs calibration for making a display coordinate system in the display device 103 and a detection coordinate system in the detecting device 105 correspond with each other. The display device 103 is for example a display device or a projector device. The detecting device 105 is for example a plane scanning sensor or a camera.

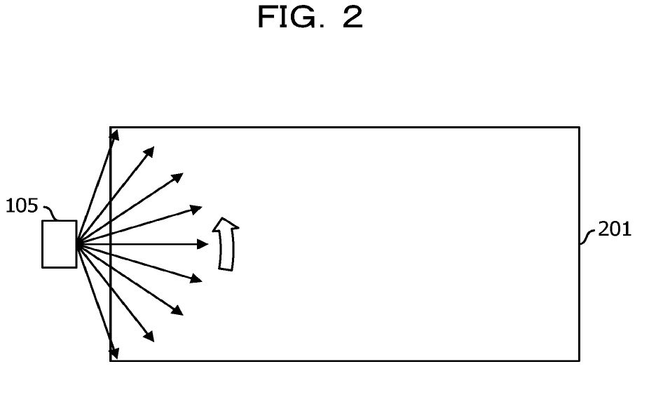

FIG. 2 illustrates a state of scanning. A display surface 201 is provided by the display device 103. When a projector device is used, a screen onto which an image is projected by the projector device corresponds to the display surface.

The detecting device 105 in the present example is a plane scanning sensor. The detecting device 105 is set on the left side of the display surface 201. However, the detecting device 105 may be set on the right side, lower side, or upper side of the display surface 201. As illustrated in FIG. 2, the detecting device 105 applies a scanning beam along the display surface 201 in a detection range at a wide angle to detect a touch position on the display surface 201. For example, irradiation in a given angle range is performed in cycles of 25 milliseconds.

However, when the detection range is too wide, an object outside the display surface is detected, thus causing noise. Accordingly, the occurrence of the noise is suppressed by setting an effective detection range appropriately.

In the present embodiment, a figure that guides a slide operation by the touch of a finger is displayed on the display surface 201, and calibration and the setting of the effective detection range are performed on the basis of a locus touched by a finger of a user. Incidentally, in the following, this figure may be referred to simply as a figure.

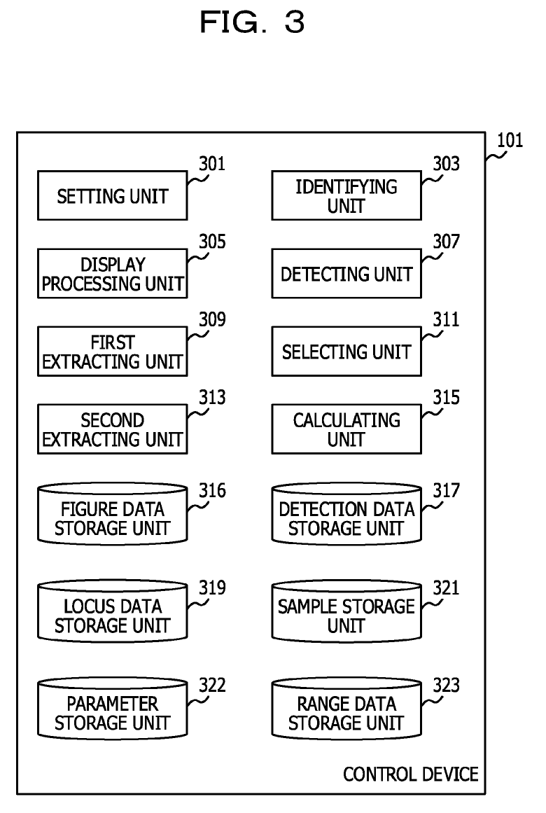

FIG. 3 illustrates an example of a module configuration of a control device. The control device illustrated in FIG. 3 may be the control device 101 illustrated in FIG. 1. The control device 101 includes a setting unit 301, an identifying unit 303, a display processing unit 305, a detecting unit 307, a first extracting unit 309, a selecting unit 311, a second extracting unit 313, a calculating unit 315, a figure data storage unit 316, a detection data storage unit 317, a locus data storage unit 319, a sample storage unit 321, a parameter storage unit 322, and a range data storage unit 323.

The setting unit 301 sets the detection range. The identifying unit 303 identifies the figure to be displayed. The display processing unit 305 displays the figure on the display device 103. The detecting unit 307 detects the position of an object. The first extracting unit 309 extracts a locus from detection data. The selecting unit 311 selects a locus coinciding with or approximate to the figure. The second extracting unit 313 extracts a matching sample that associates a display position in the display coordinate system with a detected position in the detection coordinate system. The calculating unit 315 calculates a parameter used for coordinate transformation.

The figure data storage unit 316 stores figure data. The detection data storage unit 317 stores detection data. The locus data storage unit 319 stores locus data. The sample storage unit 321 stores sample data. The parameter storage unit 322 stores the parameter used for coordinate transformation. The range data storage unit 323 stores range data.

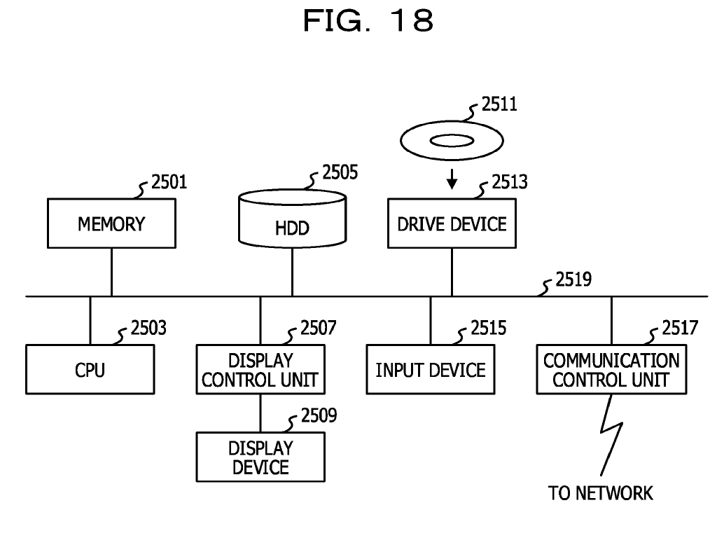

The setting unit 301, the identifying unit 303, the display processing unit 305, the detecting unit 307, the first extracting unit 309, the selecting unit 311, the second extracting unit 313, and the calculating unit 315 described above are implemented by using hardware resources (for example FIG. 18) and a program that makes a processor perform processing to be described in the following.

The figure data storage unit 316, the detection data storage unit 317, the locus data storage unit 319, the sample storage unit 321, the parameter storage unit 322, and the range data storage unit 323 described above are implemented by using hardware resources (for example FIG. 18).

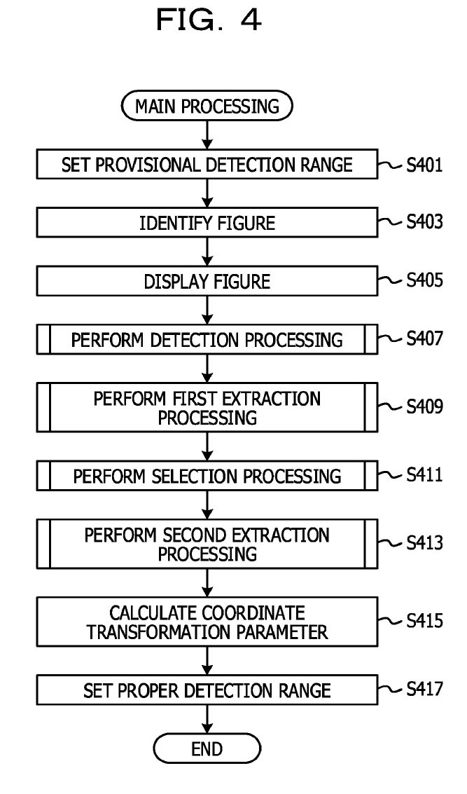

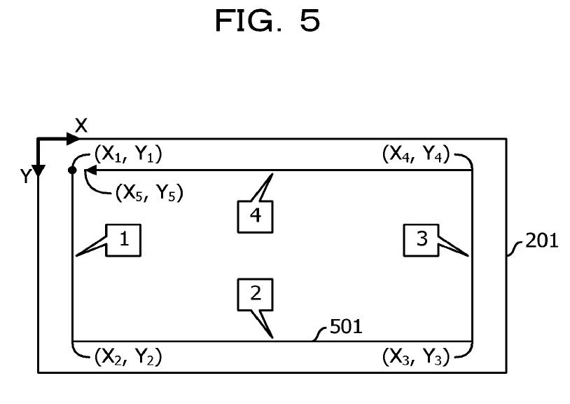

Description will next be made of processing in the control device 101. FIG. 4 illustrates an example of a flow of main processing. The setting unit 301 sets a provisional detection range to exclude unnecessary detection results in calibration (S401). When the figure data storage unit 316 stores a plurality of figures, the identifying unit 303 identifies a figure to be displayed (S403). The identifying unit 303 may allow a user to select a figure. The display processing unit 305 displays the identified figure on the display device 103 (S405). As illustrated in FIG. 5, the figure is displayed at a given position on a display surface.

FIG. 5 illustrates a state in which a figure is displayed. The origin of the display surface 201 in the present example is an upper left end point. The positive direction of an X-axis is set to be a right direction. The positive direction of a Y-axis is set to be a downward direction.

A figure 501 that guides a slide operation by a touch is displayed on the display surface 201. In the present example, numbers indicating the route of the slide are also illustrated. Along the figure 501, the user slides a touching finger downward directly from a starting point (X₁, Y₁), turns in a right direction at a corner (X₂, Y₂), turns in an upward direction at a corner (X₃, Y₃), turns in a left direction at a corner (X₄, Y₄), and reaches an endpoint (X₅, Y₅). That is, the figure 501 represents a touch route.

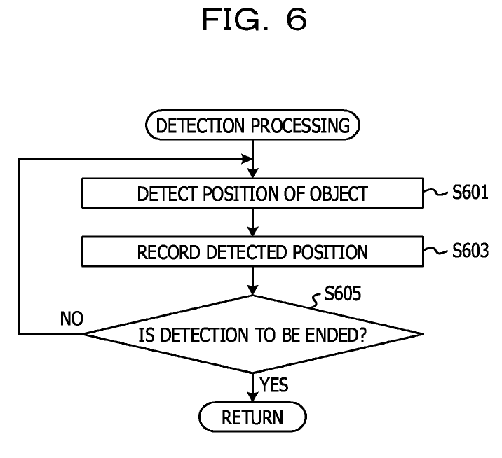

The description returns to FIG. 4. The detecting unit 307 performs detection processing (S407). FIG. 6 illustrates an example of a flow of the detection processing. The detecting unit 307 detects the position of an object in contact with the display surface 201 (S601). The detecting unit 307 records the detected position as detection data (S603). The detecting unit 307 determines whether or not to end the detection (S605). The detecting unit 307 for example determines that the detection is to be ended at a point in time that the position of the object in contact with the display surface 201 is not detected.

When the detecting unit 307 determines that the detection is not to be ended, the detecting unit 307 returns to S601 to repeat the above-described processing. When the detecting unit 307 determines that the detection is to be ended, on the other hand, the detecting unit 307 ends the detection processing to proceed to processing of S409 illustrated in FIG. 4.

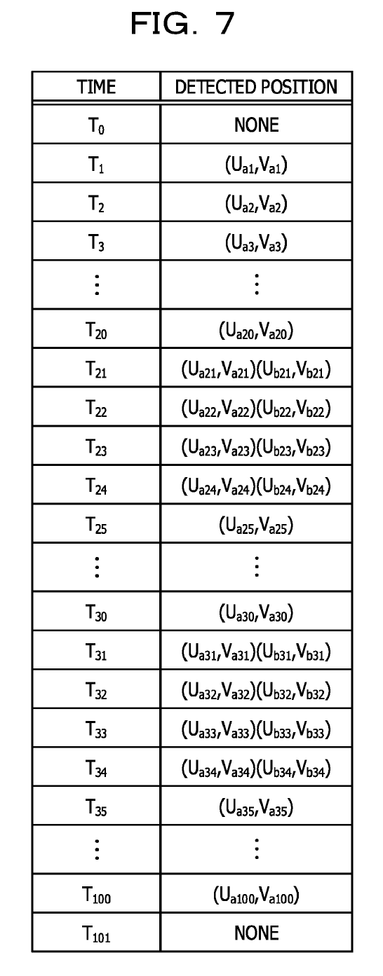

FIG. 7 illustrates an example of detection data stored in a detection data storage unit. The detection data storage unit illustrated in FIG. 7 may be the detection data storage unit 317 illustrated in FIG. 3. The detection data represents a result of sampling performed at given intervals. The detection data in the present example is in a table format. However, the detection data may be in a format other than the table format. The detection data in the present example includes records corresponding to times of detection. A record in the detection data includes a field for setting a time of detection and a field for setting a detected position. When a plurality of positions are detected, the plurality of detected positions are set. Incidentally, the detected positions in the present embodiment refer to points.

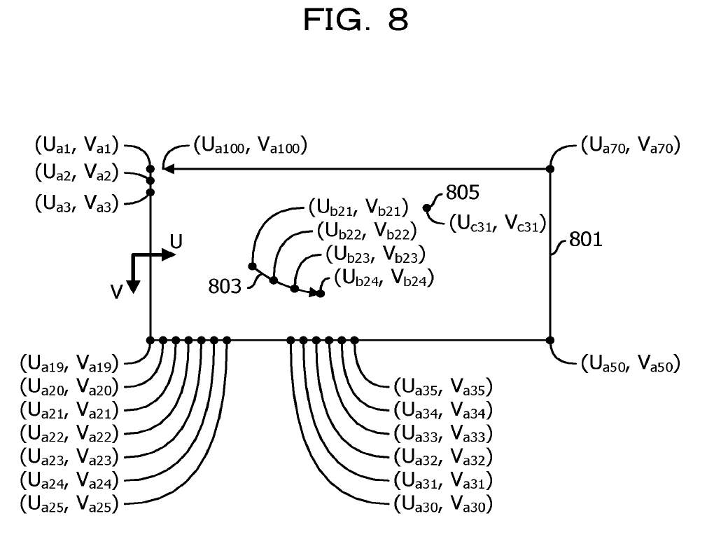

FIG. 8 is a diagram illustrating an example of loci. The detection data illustrated in FIG. 7 is based on the example of the loci illustrated in FIG. 8. Positions in FIG. 8 are based on the detection coordinate system. The origin of the detection coordinate system in the present example is provided near a center on a left side. The positive direction of a U-axis is set to be a right direction. The positive direction of a V-axis is set to be a downward direction.

A locus 801 is a locus touched by a finger of a user along the figure 501 illustrated in FIG. 5. The locus 801 from a starting point (Uₐ₁, Vₐ₁) is drawn by an intermediate point (Uₐ₂, Vₐ₂), an intermediate point (Uₐ₃, Vₐ₃), . . . , an endpoint (Uₐ₁₀₀, Vₐ₁₀₀) sequentially detected in time series. An intermediate point (Uₐ₁₉, Vₐ₁₉) corresponds to the lower left corner of the rectangle drawn by the locus 801. An intermediate point (Uₐ₅₀, Vₐ₅₀) similarly corresponds to a lower right corner. An intermediate point (Uₐ₇₀, Vₐ₇₀) similarly corresponds to an upper right corner.

A locus 803 is a locus of a detected position resulting from a noise. The locus 803 is produced by a noise of a type that involves movement of a detected position. The locus 803 from a starting point (U_{b21}, V_{b21}) is drawn by an intermediate point (U_{b22}, V_{b22}), an intermediate point (U_{b23}, V_{b23}), and an endpoint (U_{b24}, V_{b24}) sequentially detected in time series. Incidentally, the starting point (U_{b21}, V_{b21}) of the locus 803 is detected simultaneously with an intermediate point (Uₐ₂₁, Vₐ₂₁) of the locus 801. The intermediate point (U_{b22}, V_{b22}) of the locus 803 is detected simultaneously with an intermediate point (Uₐ₂₂, Vₐ₂₂) of the locus 801. The intermediate point (U_{b23}, V_{b23}) of the locus 803 is detected simultaneously with an intermediate point (Uₐ₂₃, Vₐ₂₃) of the locus 801. The endpoint (U_{b24}, V_{b24}) of the locus 803 is detected simultaneously with an intermediate point (Uₐ₂₄, Vₐ₂₄) of the locus 801. Incidentally, at a point in time that an intermediate point (Uₐ₂₀, Vₐ₂₀) of the locus 801 is detected, the noise causing the locus 803 is not produced. In addition, at a point in time that an intermediate point (Uₐ₂₅, Vₐ₂₅) of the locus 801 is detected, the noise causing the locus 803 has disappeared.

A locus 805 is also a locus of a detected position resulting from a noise. The locus 805 is produced by a noise of a type that does not involve movement of a detected position. Hence, the locus 805 is drawn by a fixed point (U_{c31}, V_{c31}). Incidentally, at a point in time that an intermediate point (Uₐ₃₀, Vₐ₃₀) of the locus 801 is detected, the noise causing the locus 805 is not produced. Suppose that the fixed point (U_{c31}, V_{c31}) of the locus 805 is thereafter detected together when intermediate points (Uₐ₃₁, Vₐ₃₁) ^{to} (Uₐ₃₄, Vₐ₃₄) of the locus 801 are detected. Suppose that the noise causing the locus 805 has disappeared at a point in time that an intermediate point (Uₐ₃₅, Vₐ₃₅) of the locus 801 is detected.

The description returns to FIG. 4. The first extracting unit 309 performs first extraction processing (S409). In the first extraction processing, the first extracting unit 309 extracts the loci from the detection data. A locus table is generated for each of the extracted loci. In the present example, locus tables are generated for the three loci illustrated in FIG. 8.

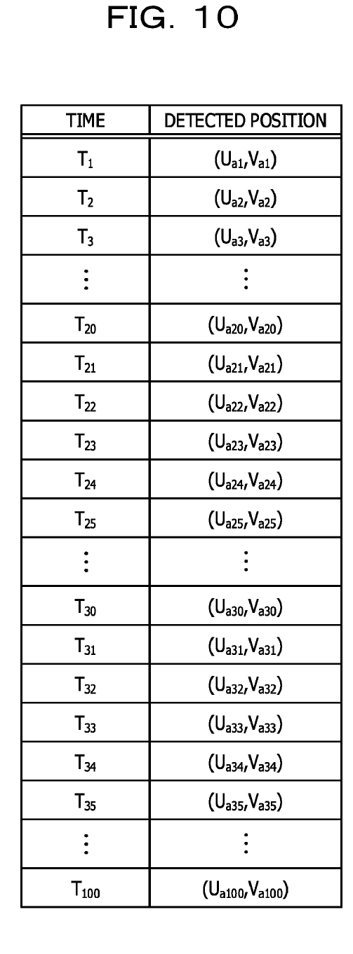

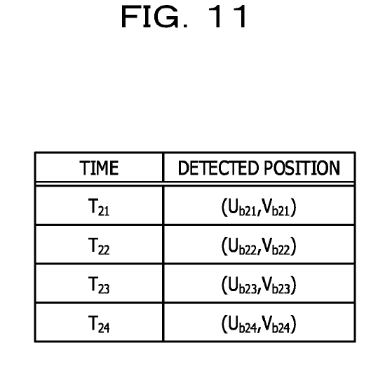

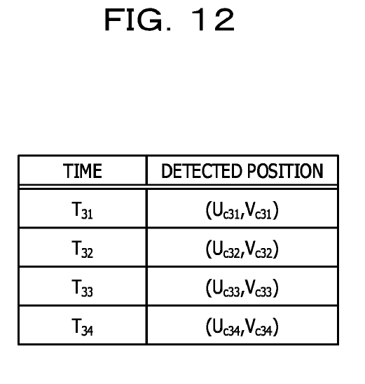

FIGS. 10 to 12 illustrate examples of locus tables. The locus tables in the present example include records corresponding to the detected positions included in the loci. A record in a locus table includes a field for setting a time of detection and a field for setting a detected position. The locus table illustrated in FIG. 10 corresponds to the locus 801 illustrated in FIG. 8. The locus table illustrated in FIG. 11 corresponds to the locus 803 illustrated in FIG. 8. The locus table illustrated in FIG. 12 corresponds to the locus 805 illustrated in FIG. 8.

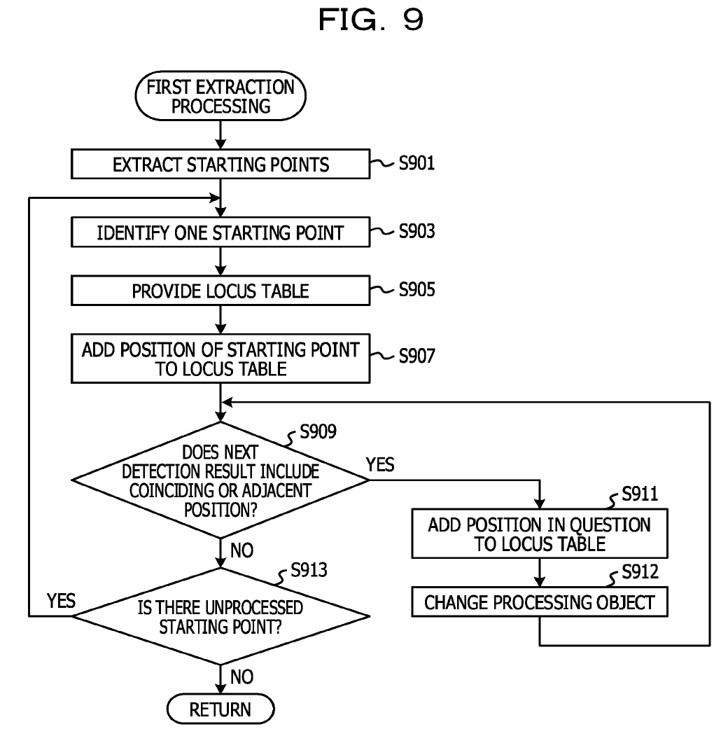

The first extraction processing in S409 will be described in detail. FIG. 9 illustrates an example of a flow of the first extraction processing. The first extracting unit 309 extracts starting points from the detection data (S901). For example, with respect to a detected position at a certain time included in the detection data, when a detection result at a time immediately preceding (previous detection result) the certain time does not include a point coinciding with or approximate to the detected position (positioned in a predetermined distance), the first extracting unit 309 determines that the detected position is a starting point. For example, a detection result at time T₀ illustrated in FIG. 7 does not include a point coinciding with or approximate to the detected position (Uₐ₁, Vₐ₁) at time T₁. The detected position (Uₐ₁, Vₐ₁) is therefore a starting point. Similarly, a detection result at time T₂₀ does not include a point coinciding with or approximate to the detected position (U_{b21}, V_{b21}) at time T₂₁. The detected position (U_{b21}, V_{b21}) is therefore a starting point. Similarly, a detection result at time T₃₀ does not include a point coinciding with or approximate to the detected position (U_{c31}, V_{c31}) at time T₃₁. The detected position (U_{c31}, V_{c31}) at time T₃₁ is therefore a starting point. Thus, in the example of FIG. 7, the three starting points are extracted.

The first extracting unit 309 identifies one starting point among the extracted starting points (S903). The first extracting unit 309 provides a new locus table (S905). The first extracting unit 309 first adds a record of the position of the starting point to the locus table (S907). At this point in time, a processing object is the position of the starting point. The first extracting unit 309 determines whether or not a detection result at a time next to a time of detection of the processing object includes a position coinciding with or adjacent to the position of the processing object (S909). When determining that the detection result includes a position coinciding with or adjacent to the position of the processing object, the first extracting unit 309 adds the record of the coinciding or adjacent position to the locus table (S911). Then, the first extracting unit 309 sets the coinciding or adjacent position as a next processing object (S912), and returns to S909 to repeat the above-described processing. Thus, a connected series of positions is extracted. Incidentally, together with each position, the first extracting unit 309 sets a time in the new record.

Then, when determining in S909 that a detection result at a time next to a time of detection of the processing object does not include a position coinciding with or adjacent to the position of the processing object, the generation of the locus table for the starting point identified in S903 is ended.

The first extracting unit 309 determines whether or not there is an unprocessed starting point (S913). When there is an unprocessed starting point, the first extracting unit 309 returns to S903 to repeat the above-described processing. When there is no unprocessed starting point, the first extraction processing is ended. The processing then proceeds to processing of S411 illustrated in FIG. 4.

The description returns to FIG. 4. The selecting unit 311 performs selection processing (S411). In the selection processing, the selecting unit 311 selects a locus coinciding with or approximate to the figure among the extracted loci.

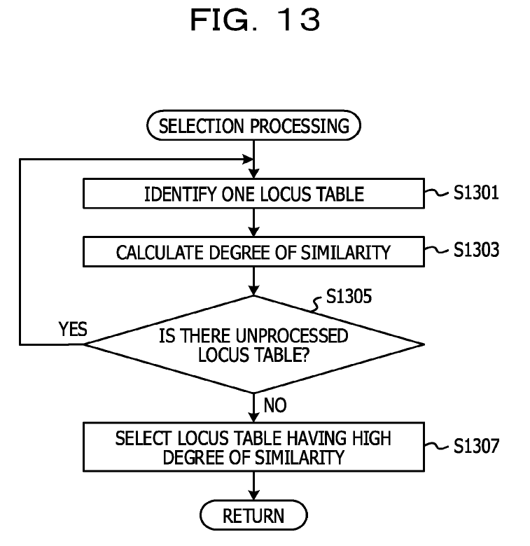

FIG. 13 illustrates an example of a flow of the selection processing. The selecting unit 311 identifies one locus table (S1301). The selecting unit 311 calculates a degree of similarity between the locus and the figure on the basis of the identified locus table and figure data (S1303). In the present example, the selecting unit 311 identifies a rectangle approximate to the locus (which rectangle is for example a rectangle circumscribing the locus). Then, the selecting unit 311 compares a characteristic of the rectangle based on the locus with a characteristic of the figure. In the present example, the selecting unit 311 sets closeness of an aspect ratio as the degree of similarity. The selecting unit 311 may add closeness of an angle at a corner as an element of the degree of similarity. In a case of a figure other than a rectangle, the selecting unit 311 may use a ratio between the lengths of respective sides in place of the aspect ratio. The degree of similarity may be calculated by another method (including conventional technologies).

The selecting unit 311 determines whether or not there is an unprocessed locus table (S1305). When determining that there is an unprocessed locus table, the selecting unit 311 returns to the processing illustrated in S1301 to repeat the above-described processing. When determining that there is no unprocessed locus table, on the other hand, the selecting unit 311 selects a locus table of a locus having a high degree of similarity (S1307). In the present example, the degree of similarity corresponding to the locus of the locus table in FIG. 10 is higher than the degree of similarity corresponding to the locus of the locus table in FIG. 11 and the degree of similarity corresponding to the locus of the locus table in FIG. 12. The locus table in FIG. 10 is therefore selected. After the selection processing is ended, the processing proceeds to processing of S413 illustrated in FIG. 4.

The description returns to FIG. 4. The second extracting unit 313 performs second extraction processing (S413). In the second extraction processing, the second extracting unit 313 extracts a matching sample for associating a display position in the display coordinate system with a detected position in the detection coordinate system.

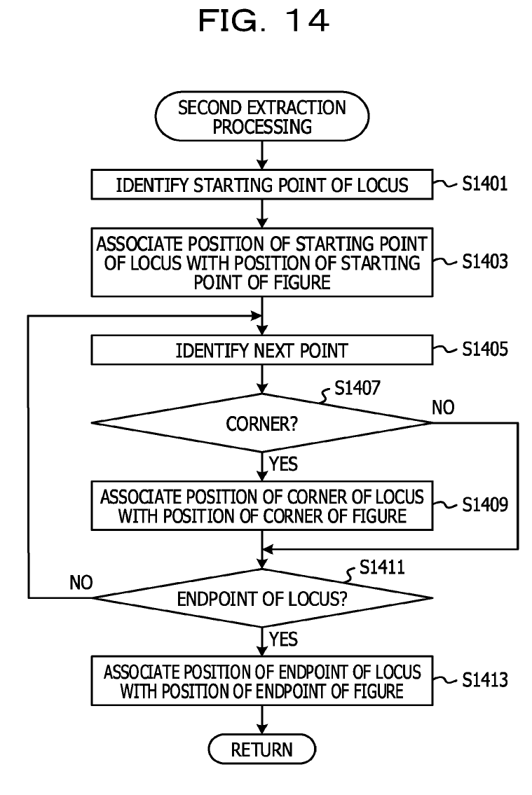

FIG. 14 illustrates an example of a flow of the second extraction processing. The second extracting unit 313 sequentially directs attention to points from the starting point to the endpoint of the locus. The second extracting unit 313 first identifies the starting point of the locus (S1401). The second extracting unit 313 adds a matching sample associating the position of the starting point of the locus with the position of the starting point of the figure to sample data stored in the sample storage unit 321 (S1403).

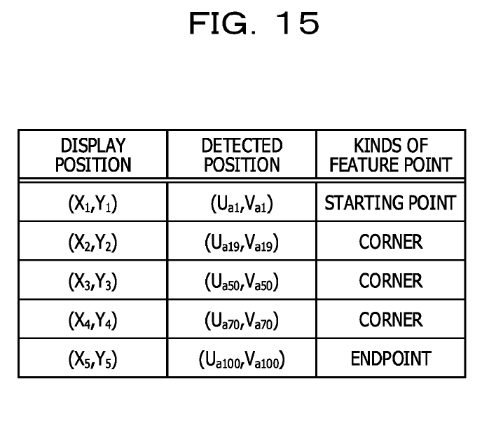

FIG. 15 illustrates an example of sample data. The sample data in the present example is in a table format. However, the sample data may be in a format other than the table format. The sample data in the present example includes records corresponding to matching samples. A record in the sample data includes a field for setting a display position, a field for setting a detected position, and a field for setting a kind of feature point.

A feature point in the present example is a starting point, a corner, or an endpoint. In a first record in the present example, the starting point (X₁, Y₁) of the figure 501 is associated with the starting point (Uₐ₁, Vₐ₁) of the locus 801. Similarly, in a second record, the lower left corner (X₂, Y₂) of the figure 501 is associated with the lower left corner (Uₐ₁₉, Vₐ₁₉) of the locus 801. Similarly, in a third record, the lower right corner (X₃, Y₃) of the figure 501 is associated with the lower right corner (Uₐ₅₀, Vₐ₅₀) of the locus 801. Similarly, in a fourth record, the upper right corner (X₄, Y₄) of the figure 501 is associated with the upper right corner (Uₐ₇₀, Vₐ₇₀) of the locus 801. Similarly, in a fifth record, the endpoint (X₅, Y₅) of the figure 501 is associated with the endpoint (Uₐ₁₀₀, Vₐ₁₀₀) of the locus 801.

The description returns to FIG. 14. When adding the matching sample associating the position of the starting point of the locus with the position of the starting point of the figure to the sample data in S1403, the second extracting unit 313 sets “starting point” as a kind of feature point.

The second extracting unit 313 identifies a next point in the locus (S1405). The second extracting unit 313 determines whether or not the identified point is a corner (S1407). The second extracting unit 313 for example determines that the point in question is a corner when an angle formed by an average of traveling directions at a few points preceding the point in question and an average of traveling directions at a few points succeeding the point in question is larger than a given value. The traveling directions correspond to directions of movement vectors. In the example of the locus 801 illustrated in FIG. 8, the detected position (Uₐ₁₉, Vₐ₁₉), the detected position (Uₐ₅₀, Vₐ₅₀), and the detected position (Uₐ₇₀, Vₐ₇₀) correspond to corners. When determining that the identified point is a corner, the second extracting unit 313 adds the matching sample associating the position of the corner of the locus with the position of the corner of the figure to the sample data (S1409). The second extracting unit 313 sets “corner” as a kind of feature point. Incidentally, the positions of the corners of the figure are identified on the basis of the figure data. When determining that the identified point is not a corner, on the other hand, the second extracting unit 313 directly proceeds to processing of S1411.

The second extracting unit 313 determines whether or not the point identified in S1405 is the endpoint of the locus (S1411). When determining that the identified point is not the endpoint of the locus, the second extracting unit 313 returns to the processing illustrated in S1405 to repeat the above-described processing.

When determining that the identified point is the endpoint of the locus, on the other hand, the second extracting unit 313 adds the matching sample associating the position of the endpoint of the locus with the position of the endpoint of the figure to the sample data (S1413). The second extracting unit 313 sets “endpoint” as a kind of feature point. Then, the second extraction processing is ended, and the processing proceeds to processing of S415 illustrated in FIG. 4.

The description returns to FIG. 4. The calculating unit 315 calculates a parameter used for coordinate transformation on the basis of the sample data (S415). A method of calculating the parameter used for coordinate transformation is based on a conventional technology such as a method of least squares, random sample consensus (RANSAC), or the like. Incidentally, the matching samples may be weighted according to the kinds of feature points. For example, the weight of a corner is increased, or the weight of a starting point is increased. Alternatively, the weight of an endpoint is increased. In addition, when a starting point and an endpoint coincide with each other or are close to each other, one of the starting point and the endpoint may be omitted. When an intermediate point on a line (for example a center of a side) is used as a feature point, the weight of the intermediate point may be decreased.

The calculated parameter is stored in the parameter storage unit 322. When the display system is thereafter used, the position of the detection coordinate system is converted into the position of the display coordinate system by using the calculated parameter. Alternatively, the position of the display coordinate system may be converted into the position of the detection coordinate system by using the calculated parameter.

The setting unit 301 sets a proper detection range (S417). For example, the setting unit 301 for example identifies a rectangle based on the locus, and stores the positions of four corners of the rectangle as a parameter representing a detection range in the range data storage unit 323. Incidentally, the detection range set at this time may be referred to also as an effective range. The rectangle based on the locus is for example a rectangle circumscribed about the locus or a rectangle inscribed in the locus. In addition, the detection range may be set with a margin region added around the rectangle based on the locus.

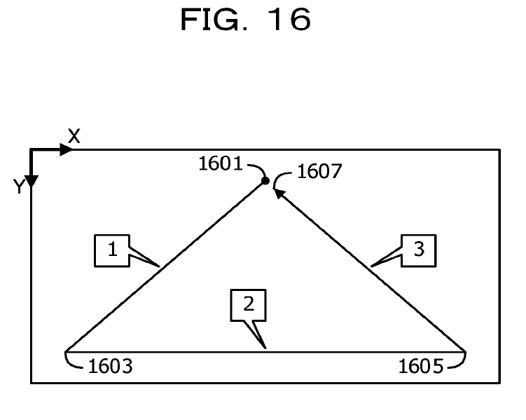

FIG. 5 illustrates an example of a rectangular figure. However, a figure other than a rectangle may be used. FIG. 16 illustrates an example of another figure. When this figure is displayed, along the figure, the user slides a touching finger leftwardly downward from a starting point 1601, turns in a right direction at a corner 1603, turns in a leftwardly upward direction at a corner 1605, and reaches an endpoint 1607. In this figure, the starting point 1601, the corner 1603, the corner 1605, and the endpoint 1607 are feature points.

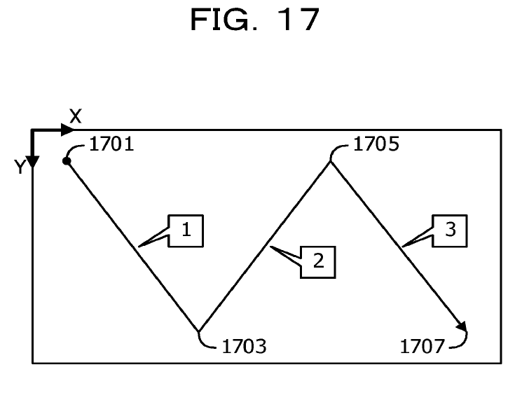

FIG. 17 illustrates an example of yet another figure. When this figure is displayed, along the figure, the user slides a touching finger rightwardly downward from a starting point 1701, turns in a rightwardly upward direction at a corner 1703, turns in a rightwardly downward direction at a corner 1705, and reaches an endpoint 1707. In this figure, the starting point 1701, the corner 1703, the corner 1705, and the endpoint 1707 are feature points.

The accuracy of calibration is expected to be increased when a figure thus having three feature points not aligned on one straight line is used. Coordinate transformation may not be performed correctly in a case of a parameter calculated on the basis of a linear matching pattern.

In addition, more matching samples may be extracted by detecting touch positions on a plurality of figures.

Points other than starting points, corners, or endpoints may be used as feature points. For example, an intermediate point on a line (for example a center of a side) may be used as a feature point.

Incidentally, in an environment using such a display system, various kinds of cooperative operations are expected to be performed between a portable terminal device and the display system. For example, the portable terminal device and the display system may perform various kinds of cooperative operations in response to a cooperation request from the portable terminal device to the display system. The display system may detect the portable terminal device of a person entering a room in which the display device 103 is installed, and automatically distribute a particular program to the portable terminal device. The portable terminal device may automatically start the received particular program. The portable terminal device and the display system may synchronize data or processes. Processing in the display system may be controlled by operation on the portable terminal device, or processing in the portable terminal device may be controlled by operation on the display system.

According to the present embodiment, it is possible to perform calibration more correctly for the display system that detects a position touched by a user. This is because a locus based on noise is removed as a locus not approximate to the figure. That is, effect of noise is removed.

In addition, the work of setting a detection range in the detecting device 105 can be omitted.

Samples are weighted according to kinds of feature points. Thus, the relation between the display coordinate system of the display device 103 and the detection coordinate system of the detecting device 105 can be reflected in the parameter more correctly according to the strength of the features.

One embodiment of the present technology has been described above. However, the present technology is not limited to this. For example, the above-described functional block configuration may not coincide with a program module configuration.

In addition, the configuration of each storage area described above is an example, and is not limited to the configuration as described above. Further, also in a processing flow, the order of pieces of processing may be changed or a plurality of pieces of processing may be performed in parallel with each other unless a processing result is changed.

The control device 101 described above is a computer device in which as illustrated in FIG. 18 (incidentally, FIG. 18 is a functional block diagram of a computer), a memory 2501, a central processing unit (CPU) 2503, a hard disk drive (HDD) 2505, a display control unit 2507 coupled to a display device 2509, a drive device 2513 for a removable disk 2511, an input device 2515, and a communication control unit 2517 for coupling a network are coupled to each other via a bus 2519. An operating system (OS) and an application program for performing the processing in the present embodiment are stored on the HDD 2505. When the operating system and the application program are to be executed by the CPU 2503, the operating system and the application program are read from the HDD 2505 into the memory 2501. The CPU 2503 controls the display control unit 2507, the communication control unit 2517, and the drive device 2513 to perform given operation according to the processing contents of the application program. In addition, data in the middle of processing is stored mainly in the memory 2501, but may be stored on the HDD 2505. In the embodiment of the present technology, the application program for performing the processing described above is distributed in a state of being stored on the computer readable removable disk 2511, and installed from the drive device 2513 onto the HDD 2505. The application program may be installed onto the HDD 2505 via a network such as the Internet or the like and the communication control unit 2517. In such a computer device, hardware such as the CPU 2503, the memory 2501, and the like described above and programs such as the OS, the application program, and the like organically cooperate with each other to thereby implement various kinds of functions as described above.

The embodiment of the present technology described above is summarized as follows.

A calibration method according to one of the embodiments includes: making a display device display a figure indicating a touch route, receiving a plurality of detection results from a detection device, each of the plurality of detection results including one or more touch positions on a surface on which the figure is displayed in each detection timing, extracting one or more loci based on the plurality of detection results; and when the extracted one or more loci include a plurality of loci, executing a calibration based on a corresponding locus coinciding with or approximate to the figure, the corresponding locus being included in the plurality of loci.

Thus, calibration can be performed more correctly for a display system that detects the position touched by a user.

The calibration method may further include setting a detection range in the detecting device on the basis of the corresponding locus.

Thus, the work of setting the detection range in the detecting device can be omitted.

Further, the calculating may weight a sample according to a kind of the feature point.

Thus, relation between the display coordinate system of the display device and the detection coordinate system of the detecting device can be reflected in the parameter more correctly according to a geometric characteristic of the feature point.

Incidentally, a program for making a computer perform processing based on the method can be created. The program may be stored on a computer readable storage medium or a storage device such for example as a flexible disk, a compact disc read-only memory (CD-ROM), a magneto-optical disk, a semiconductor memory, or a hard disk. Incidentally, an intermediate processing result is generally stored temporarily in a storage device such as a main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A calibration method performed by a computer, the calibration method comprising:
making a display device display a figure indicating a touch route;
receiving a plurality of detection results from a detection device, each of the plurality of detection results including one or more touch positions on a surface on which the figure is displayed in each detection timing;
extracting one or more loci based on the plurality of detection results; and
when the extracted one or more loci include a plurality of loci, executing a calibration based on a corresponding locus coinciding with or approximate to the figure, the corresponding locus being included in the plurality of loci.

2. The calibration method according to claim 1, further comprising:
determining whether a first touch position is included in the one or more touch position of first detection result, the first touch position being in a predetermined distance from a second position that is a position included in a second detection result, each of the first detection result and the second detection result being included in the plurality of detection results, the first detection result being obtained at a next detection timing of the second detection result; and
determining that the first touch position and the second touch position are touch positions touched continuously when it is determined that the first touch position is included in the one or more touch position of first detection result; wherein
in the extracting, each of the one or more loci is extracted based on the touch positions touched continuously.

3. The calibration method according to claim 1, further comprising:
selecting the corresponding locus among from the plurality of loci based on data including an aspect ratio of the figure and an aspect ratio of each of the plurality of loci.

4. The calibration method according to claim 3, wherein
the data further include information on a plurality of feature points for each of the figure and the plurality of loci; and
calculating, in the calibration, a parameter used for coordinate transformation between a display coordinate system of the display device and a detection coordinate system of the detection device based on the plurality of feature points weighted according to a kind of each of the plurality of feature points.

5. The calibration method according to claim 1, further comprising:
setting a detection range in the detection device based on the corresponding locus.

6. A non-transitory computer-readable recording medium storing a calibration program that causes a computer to execute a process comprising:
making a display device display a figure indicating a touch route;
receiving a plurality of detection results from a detection device, each of the plurality of detection results including one or more touch positions on a surface on which the figure is displayed in each detection timing;
extracting one or more loci based on the plurality of detection results; and
when the extracted one or more loci include a plurality of loci, executing a calibration based on a corresponding locus coinciding with or approximate to the figure, the corresponding locus being included in the plurality of loci.

7. A calibration device comprising:
a memory; and
a processor coupled to the memory and configured to:
make a display device display a figure indicating a touch route;
receive a plurality of detection results from a detection device, each of the plurality of detection results including one or more touch positions on a surface on which the figure is displayed in each detection timing;
extract one or more loci based on the plurality of detection results; and
when the extracted one or more loci include a plurality of loci, execute a calibration based on a corresponding locus coinciding with or approximate to the figure, the corresponding locus being included in the plurality of loci.
